(19) United States
(12) Patent Application Publication
(10) Pub. No.: US 2017/0083893 A1
(43) Pub. Date: Mar. 23, 2017

(54) POINT OF SALE PAYMENT SYSTEM

(71) Applicant: VIATAP, INC., LAFAYETTE, CA (US)

(72) Inventors: Darren Beyer, Lafayette, CA (US); Jeremy Bjorem, Kansas City, MO (US)

(21) Appl. No.: 15/271,482

(22) Filed: Sep. 21, 2016

Related U.S. Application Data
(60) Provisional application No. 62/222,469, filed on Sep. 23, 2015.

(51) Int. Cl. G06Q 20/20; G06Q 30/02; G06Q 20/32

(52) U.S. Cl. CPC G06Q 20/209; G06Q 20/3278; G06Q 20/3223; G06Q 30/0238

(57) ABSTRACT

Conducting payment transactions at merchant locations away from direct interaction with a point-of-sale system. These embodiments may include a physical remote device (PRD) supplied to interact with a customer's mobile device by collecting transaction information through printer interactions and wirelessly coupling that information to a mobile device in response to interactions with the physical remote device thus allowing a remote host system to coordinate with a merchants existing point-of-sale payment system. Certain embodiments may include a processor-based PRD and instructions for controlling a communications port using either USB or Bluetooth and short-range wireless communications system such as Bluetooth low energy (BLE) or near field communication (NFC).

### PRIORITY

This application claims the benefit of US Provisional Patent application No. 62/222,469 entitled “Point of sale payment system” filed Sep. 23, 2015 by the same inventors, which is hereby incorporated by reference, together with its Appendix, as if fully set forth herein.

### BACKGROUND

Conventionally merchants have been processing mobile payments at the point of sale via direct interaction with a customer's mobile device. This may be performed utilizing an optical QR code or a wireless technology such as near field communication (NFC) to be scanned directly at the point of sale to make the handshake with the customer's mobile device. However, in many scenarios, such as delivery and casual dining, the point of sale is too far away from the customer to make such interaction convenient. As such, conventional methods are not a positive consumer experience or potentially even possible at some merchant types.

Additionally, a significant disadvantage of current merchant mobile payment implementations is that significant system integration is required to enable mobile payments at the point of sale. Even more, expensive integration is required if the mobile device or associated host system is to capture information about goods and services purchased.

### SUMMARY

Disclosed herein are systems and methods for facilitating transactions between a merchant's point of sale system and a customer who may be located at a distance from the point of sale system. These embodiments may include a physical remote device supplied to interact with a customer's mobile device thus allowing a remote host system to coordinate with a merchants existing point-of-sale payment system.

Also disclosed is information on conducting payment transactions at merchant locations away from direct interaction with a point-of-sale system. These embodiments may include a physical remote device (PRD) supplied to interact with a customer's mobile device by collecting transaction information through printer interactions and wirelessly coupling that information to a mobile device in response to interactions with the physical remote device thus allowing a remote host system to coordinate with a merchants existing point-of-sale payment system. Certain embodiments may include a processor-based PRD and instructions for controlling a communications port using either USB or Bluetooth and short-range wireless communications system such as Bluetooth low energy (BLE) or near field communication (NFC).

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 describes an overview of a process which may be effectuated in certain embodiments.

FIG. 2 describes some of the components of the system and the relationship between them.

FIG. 3 shows the steps of a representative process of effecting transactions in some embodiments.

FIG. 3A illustrates a process for multiple payees to proffer payment.

FIG. 3B shows the system supporting an offer, coupon or similar discount.

FIG. 3C shows a process for adding a tip.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

Embodiments of the present invention relate to utilizing one or more of the following components to complete a transaction at a merchant location. There is however, no requirement that all of the system elements be used or that they be used in any particular combination.

Merchant point of sale system

Receipt/check data extraction mechanism

Customer mobile device and associated application

Merchant mobile device and associated application

Merchant physical remote device

A host system

A third party payment processor

By using some or all of the system elements, a process for consumer purchase may be effectuated. In an exemplary embodiment a consumer may place an order for goods or services and be delivered a bill-of-sale (a receipt or check) indicating such services, line item pricing, associated tax and total to be paid by the consumer. In some embodiments, such as in restaurants, an open location for an optional tip may be present. Along with the receipt/check may be delivered a physical remote device (PRD) for effecting the transaction. The PRD may be constructed in a variety of forms as presented herein.

The consumer may access their mobile device, such as a cell phone, tablet and the like, and an associated application and perform a linking to the PRD. Following the link, the mobile device may display a receipt/check displaying showing transaction information such as the tax, total and line items of the goods/services the consumer ordered. The consumer may choose to add or dispute an amount. The consumer may also choose a payment method or may use a default payment method to pay. The mobile device may send a payment transaction to the appropriate third party payment processor. Following payment processing, the merchant may be notified of payment in the point of sale system or in an optional merchant mobile device operating an associated application.

The merchant transactions may be accomplished with a variety of payment types and payment processors. Payment types may include, but are not limited to:

Credit/debit cards

Merchant stored value cards

Merchant coupons, rewards and discounts

Manufacturer coupons,

Third party wallets such as ApplePay or PayPal

Digital currencies such as BitCoin

Value that may be assigned to the user's mobile device bill

Other forms of digital value

Embodiments disclosed herein provide advantages for merchants including lowering wait times, speeding line times, capturing customer data, encouraging loyalty use, encouraging coupon/offer use and more. Other embodiments may allow for multiple customers on a single check to each individually engage with the PRD and split the bill as they see fit. And other embodiments may allow for a merchant employee/server to display personal information such as a photo or greeting to encourage tipping or simulate customer loyalty, for example by connecting to social media.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Detailed Operation

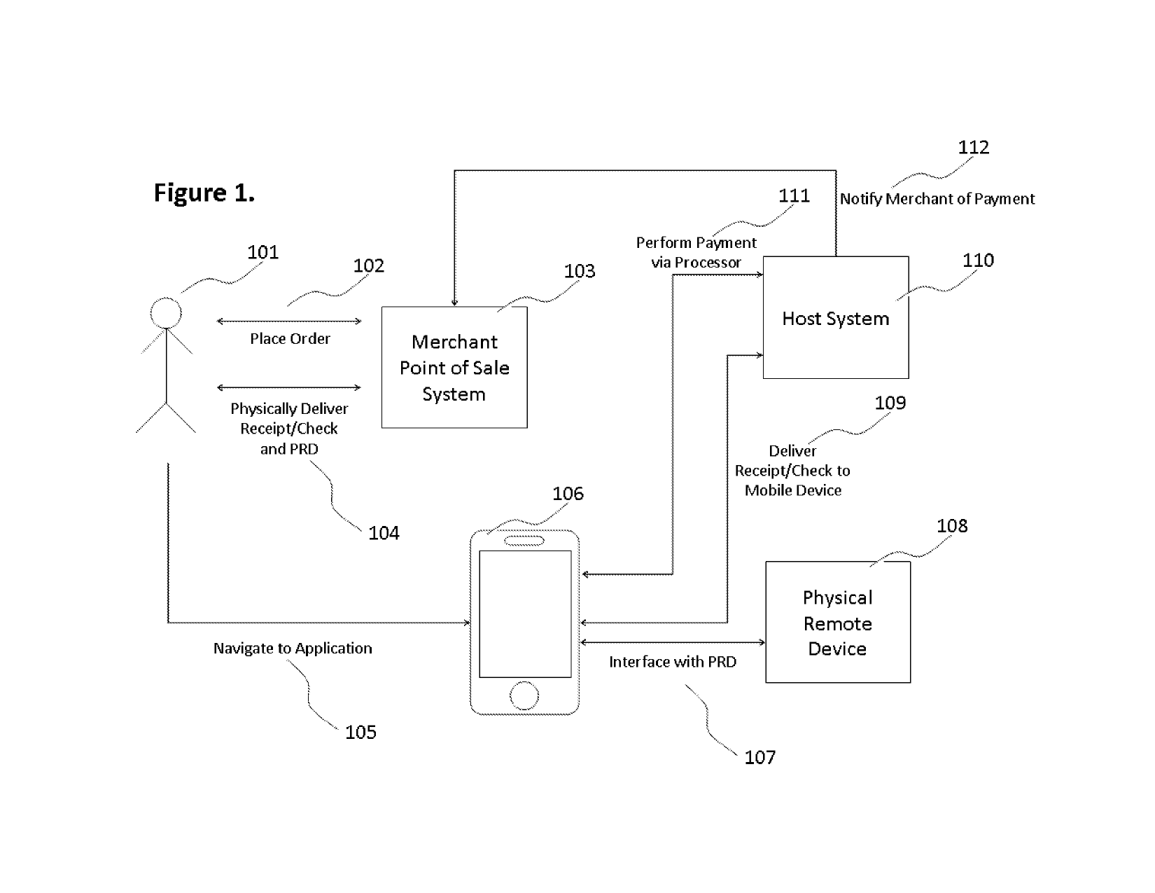

FIG. 1 describes an overview of a process which may be effectuated in certain embodiments. The consumer 101 places an order 102 with a merchant/point of sale system 103. The customer may or may not interface directly with the point of sale system 103, but an agent of the consumer or merchant may interact with the point of sale system 103 instead. The merchant may deliver 104 the receipt and associated PRD 108. The consumer may then utilize the mobile device and associated application 106 to navigate to a payment interface 105. The consumer will interface with the PRD utilizing the mobile device 107. The mobile device may receive the receipt/check and display it on the screen 109. The consumer may use the mobile device to perform a financial transaction utilizing third party processor 111 by accessing the host system (server) 110. The host system may notify the merchant of payment 112.

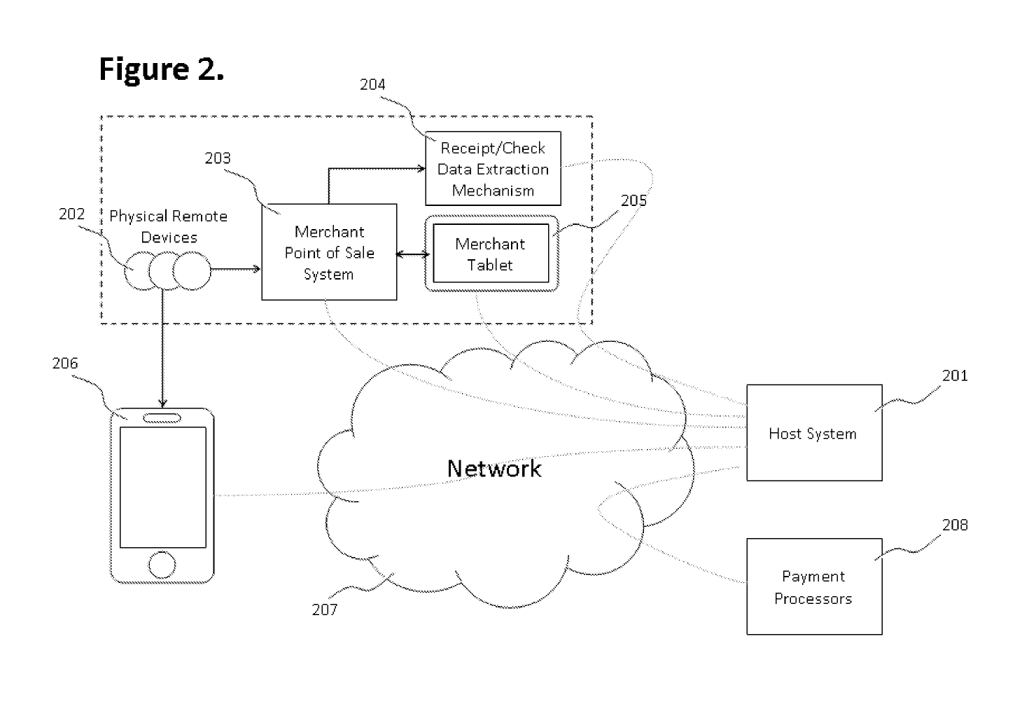

FIG. 2 describes some of the components of the system and the relationship between them. The host system 201 is a central component responsible for a number of functions including coupon/discount system of record, coupon/discount processing, system of record for receipt/check acceptance and storage, central system for initiating payments via third party processors, communicating with the mobile device, tablet device, merchant point of sale (POS) and receipt/check data extraction mechanism. All communication between the host system and other components may be accomplished via data network. The physical remote devices 202 represent the connecting mechanism between check and mobile device/application by including communications ports, a controller (or processor), and memory with instructions programming the controller as described herein.

The merchant point of sale system 203 is the mechanism by which the merchant takes orders and processes local payments. In some embodiments the host system interfaces directly with the point of sale system. The receipt/check data extraction mechanism 204 may take digital or physical forms and represents a method for retrieving receipt/check data from the point of sale system. Note that in some embodiments this may be represented via direct host integration to the point of sale system. The merchant interface (tablet) 205 represents a mechanism for notifying the merchant that payment has taken place for a specified check and may be utilized in some embodiments for other merchant/host communications. The mobile device and associated application 206 represents a mechanism for the customer to interface with physical remote devices and the host system. The network 207 represents a communication mechanism between multiple components in the system. This may take the form of both wired and wireless networks. Payment processors 208 represent one or more third party providers such as online merchant processors and third party wallets such as PayPal and ApplePay. In some embodiments this may be encompassed in the host system as an included function. In some embodiments the merchant tablet 205 or similar device may communicate with each other, acting as a conduit to the host system.

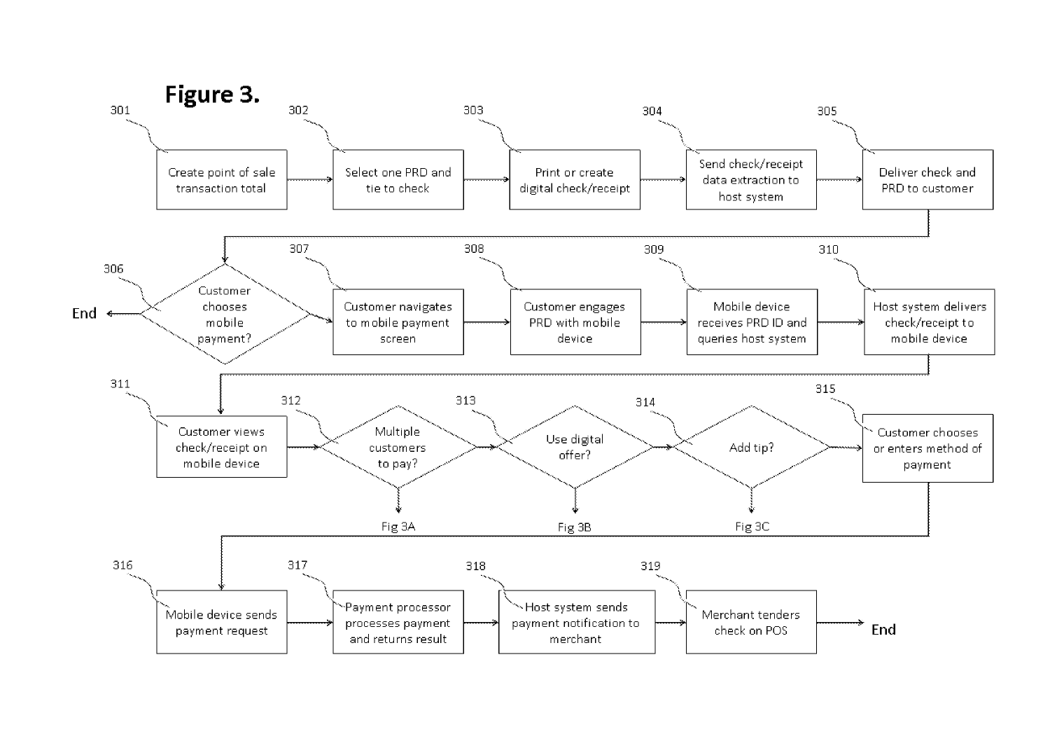

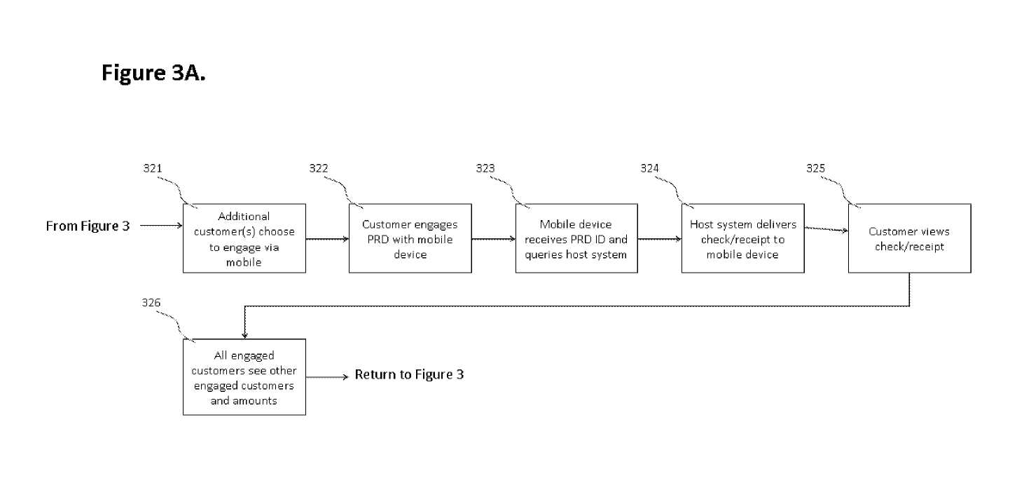

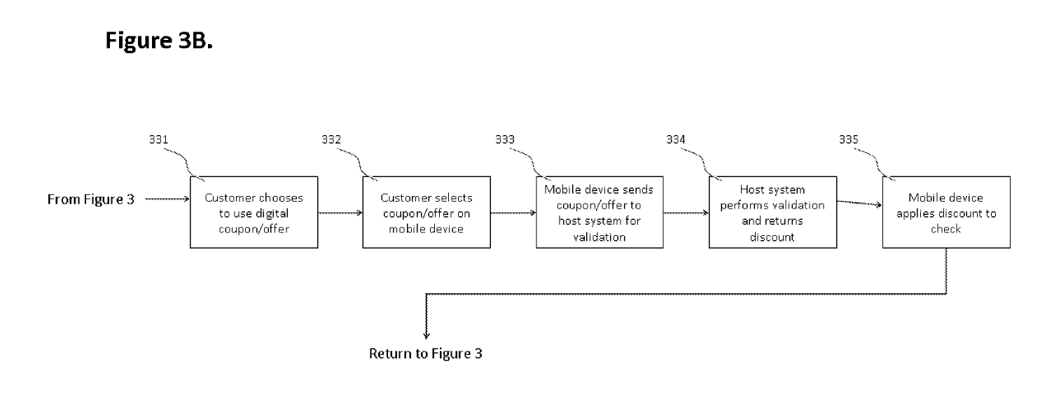

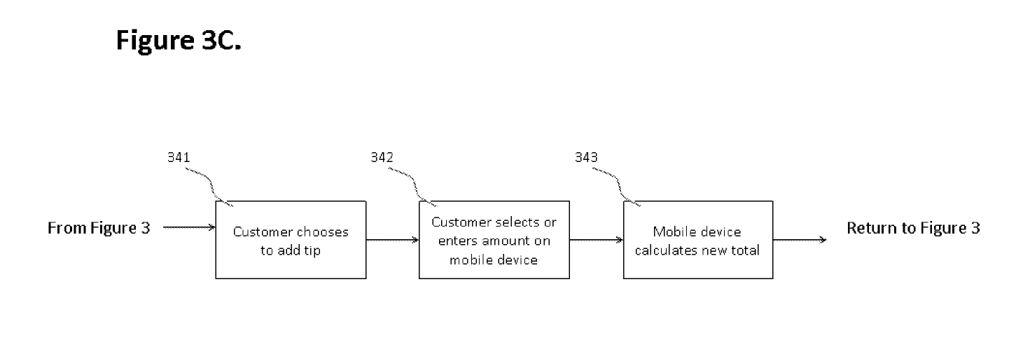

FIG. 3 shows the steps of a representative process of effecting transactions in some embodiments. The merchant may create a point of sale transaction 301, select a PRD and attach it to the check 302, and print a physical or digital receipt/check 303. In some embodiments the PRD may be linked to the receipt/check before, during or after services/goods are delivered. The data extract of the receipt/check may be sent to the host system 304. The receipt/check and PRD may be delivered to the customer 305 and the customer chooses to pay via mobile device 306. It should be noted that in some embodiments the PRD may be delivered prior to this step or after this step depending on business processes. The customer navigates to the mobile payment screen 307 and engages with the PRD 308. During this engagement, the identifier of the PRD 308 is exchanged with the mobile device 306. The mode of this engagement may be via wireless signal such as Bluetooth Low Energy (BLE) or near filed communication (NFC), optical such as scanning a bar code or sound, or other channels such as WiFi, cellular and the like.

Following the exchange, the mobile device sends identification from the PRD to the host system 309, the host system 304 retrieves the receipt/check and delivers it to the mobile device 310. The customer views the receipt/check on the mobile device 311. Multiple customers may engage the PRD 312. This process is depicted on FIG. 3A. In some embodiments the customer may choose to utilize a digital offer or coupon 313. This process is depicted on FIG. 3B. The customer may choose to add a tip 314 (see FIG. 3C). The customer may also choose to enter a method of payment 315. This method may be an existing credit/debit card, stored value account, third party wallet or any other manner of digital currency or wallet. Note that the customer may choose multiple payment methods for an individual transaction. Also if no payment method is chosen, the engagement may still occur and value deducted from the check due to offers/coupons being utilized or other value being consumed such as loyalty points. The mobile device sends a payment request 316. The request may come directly from the mobile device or may be sent to the host first then the host sends the request depending on the nature of the payment type. In either case the host may have notification that the payment request is taking place. The payment processor performs a payment transaction against the payment source and returns a result 317. If the mobile device initiated the payment request, the host system may be notified of the result. The host system sends notification of full or partial payment to the merchant 318. This notification may be to a mobile/tablet device, computer, receipt printer or any other device capable displaying the results of the transactions. This notification may also be directly to the merchant point of sale system. This notification may contain total amount(s) processed, utilization of offers/coupons and tips. The merchant then tenders the check on the point of sale system for the specified amount(s) 319. Note that this may occur manually or automatically. Note that this may represent a full, partial or no payment of the check.

### Multiple Payees

FIG. 3A illustrates a process for multiple payees to proffer payment. Multiple engagements of the PRD may allow for a split check scenario where multiple people contribute to paying. An additional customer may choose to engage (321) in the same manner as the initial customer did 322. As with the original customer, the mobile device receives identification information from the PRD and queries the host system for the receipt/check 323. As with the original customer, the host system sends the receipt/check to the mobile device 324 and the additional customer may review the receipt/check 325. Both the original customer and any additional customers may see the others' amounts entered and may enter amounts of their own 326. Additional customers may follow the same process as the original customer as it pertains to adding offers/coupons and tips.

### Accepting Coupons

FIG. 3B shows the system supporting an offer, coupon or similar discount. In these process steps the customer chooses to use a coupon mechanism 331. Then the customer may select an offer from the mobile device to add to the check 332. The mobile device may send the offer/coupon information to the host system for the purpose of validation and to receive a discount amount 333. The host system may validate the amount and return the amount to the mobile device 334. The mobile device may then apply the returned discount amount to the check 335.

### Tipping

FIG. 3C shows a process for adding a tip. In this process the customer chooses to add a tip to the check 341. The customer may select or enter the amount of the tip on the mobile device 342. The mobile device may calculate a new amount based on the tip amount entered 343.

### Operational Information

One embodiment according to the current disclosure is using a mobile device to complete a payment transaction between a customer and a merchant, where the consumer's mobile device engages a PRD and upon engagement, the merchant transmits a detailed check (or receipt) for goods sold or services rendered to a consumer's mobile device whereby the consumer chooses a method of payment, adds any gratuity and sends payment information for processing. Payment processing may include, but is not limited to, a merchant stored value card, a credit card, a debit card, loyalty points, a merchant offer or any third party wallet. Once payment is processed, an acknowledgement indication is sent to the merchant information system indicating a payment on the appropriate check. In some embodiments multiple customers may engage the same physical device for the same receipt and split the payment between them.

### Engagement Mechanism

The engagement mechanism may be Bluetooth Low Energy, NFC, optical data, noise data, hardwire, WiFi or other method for transmitting the identifier of the merchant's physical remote device to the customer's mobile device. To provide for capture some embodiments may include a physical device disposed between the point of sale and receipt printer. The data may be captured by a digital object or program on the point of sale computing machine or associated “back of the house” machine that would be transmitted to the PRD or imprinted on the check/receipt. In other embodiments, the PRD may be configured as a wireless printer so when a merchant's point-of-sale system prints a receipt; the PRD captures all the receipt information by emulating a printer. Other embodiments may include a PRD coupled to the merchant's printer or USB port using a cable. These embodiments provide for programmable hardware in the PRD to interact wirelessly or directly with the merchant's point-of-sale system and with a with a user's mobile device.

Some embodiment may include a unique physical identifier such as a zero-value SKU, a printed bar-code, and the like that may be disposed on the check and used for linking the check number to the host system. The zero-value SKU (or bar code) may be disposed on the check/receipt as a zero value sales function, or a unique identifier. The unique physical identifier provides an indicia on the check/receipt for engagement by allowing the customer to scan the bar code. The zero-value indicia may be programmed into a merchant's point-of-sale system as an order item or as a unique check/receipt identifier. Certain embodiments may allow for the physical remote device to be affixed to a location such as a table in a restaurant and linked to the check by the table number. In some embodiments PRD may be linked to the check at the time the customer enters an establishment similar to devices that alert a waiting customer that a table is ready or push notifications from the establishment or third party system that indicate when a table is available at a restaurant such as OpenTable.

In some embodiments the PRD may engagement the merchant system by receiving check information in parallel to a printing system by “sniffing” the wireless signal to the printer. This allows for a server to deliver a printed receipt and a PRD to a user without any hardware or software modifications to an existing point-of-sale system. Conventional packet sniffing or packet analysis (also known as a network analysis, protocol analysis, or wireless sniffing) is a computer program or piece of computer hardware that can intercept and log traffic that passes over a digital network or part of a network. This may be accomplished wirelessly through conventional wireless technologies. As data streams flow across the network, the sniffer captures each packet and, if needed, decodes the packet's raw data, showing the values of various fields in the packet, and analyzes its content according to the appropriate specifications.

### Mobile Devices

The mobile device may capture the PRD information in several ways. In some embodiments it may initiate capture through a built-in accelerometer in the mobile device. This would trigger short-range wireless communications systems such as Bluetooth Low Energy, NFC or other mechanism to capture identification information on the check/receipt when the accelerometer indicates certain motions or crosses a threshold acceleration. Some embodiments may include a physical touching of the mobile device to the PRD such as a short tap, while other may include scanning the indicia manually, or through other physical interactions with the mobile device.

The mobile device may be equipped with global positioning information such as GPS, which may indicate to the mobile device its location. By capturing the information from the PRD and knowing the mobile device's location, payment operations are facilitated using the host system. Certain embodiments may allow for communications between differing mobile devices facilitated by the host system to effectuate payment through mobile devices that are not present at the facility or close to the PRD.

Once the mobile device captures the physical remote device identifier, the mobile device may communicate that information to a host system to retrieve the check/receipt data so the payment data may be displayed as a comprehensive list of services/goods, taxes and total owed by the customer. In some embodiments merchant, employee, or server information may be compiled and sent with the payment data to the mobile device thus tying a person to the check or receipt. This information may be provided by the host system or through communications with the merchant's POS system. For example and without limitation, some embodiments may show a picture and name of the server on the check.

Embodiments may also include available digital offers, discounts, coupons, rewards, loyalty points and other merchant value that may be applied as payment. Once the mobile device user enters payment information the payment processing results may be sent to the host system and/or the merchant system to be applied to the specified check. The payment processing result may be sent directly to the merchant point of sale system and applied directly to the specified check.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

We claim:

1. A device including:
a communications port, said communications port coupled to a processor;
a short-range wireless communication system, said wireless communication system coupled to the processor;
an accelerometer coupled to the processor;
a non-transitory memory coupled to the processor, said memory including processor instructions directing the processor to perform a method comprising:
emulating a printer using the communications port to receive a sale information;
detecting a pre-determined motion from the accelerometer;
wirelessly coupling to a mobile device with the short-range communication system, and
exchanging at least a portion of the sale information with the mobile device.

2. The device of claim 1 wherein the communications port is at least one of either a USB or a Bluetooth port.

3. The device of claim 1 wherein the short-range wireless communications system is at least one of either Bluetooth low energy (BLE) or near field communication (NFC).

4. The device of claim 1 wherein the communications port is a wireless port and the method step of emulating a printer includes packet analysis of wireless transmissions.

5. A device including:
an optical port, said optical port coupled to a processor and operable to scan indicia;
a short-range wireless communication system, said wireless communication system coupled to the processor;
an accelerometer coupled to the processor;
a non-transitory memory coupled to the processor, said memory including processor instructions directing the processor to perform a method comprising:
scanning an indicia, said indicia including a sale information;
detecting a pre-determined motion from the accelerometer;
wirelessly coupling to a mobile device with the short-range communication system, and
exchanging at least a portion of the sale information with the mobile device.

6. The device of claim 5 wherein the short-range wireless communications system is at least one of either Bluetooth low energy (BLE) or near field communication (NFC).

7. The device of claim 5 wherein the communications port is a wireless port and the method step of emulating a printer includes packet analysis of wireless transmissions.

8. The device of claim 5 wherein the predetermined motion is a sharp tap.

9. A method including:
receiving, at a processor-controlled device, a sale information;
detecting a physical motion at the processor-controlled device;
wirelessly transmitting, in response to said detecting, said sale information to a mobile device, said mobile device operable to facilitate an electronic payment.

10. The method of claim 9 wherein said detecting is effectuated using an accelerometer.

11. The method of claim 9 wherein said receiving is effectuated by optically scanning a printed indicium.

12. The method of claim 9 where said receiving is effectuated by analyzing wireless packet information.

13. The method of claim 9 wherein the mobile device is a mobile phone.
